(19) United States
(12) Patent Application Publication
(10) Pub. No.: US 2026/0186876 A1
(43) Pub. Date: Jul. 2, 2026

(54) OPEN-VOCABULARY APPLICATION PROGRAMMING INTERFACE CALLS

(71) Applicant: GOOGLE LLC, Mountain View, CA (US)

(72) Inventors: Jürgen Sturm, München (DE); Francis Engelmann, Lugano (CH)

(21) Appl. No.: 19/431,073

(22) Filed: Dec. 23, 2025

Related U.S. Application Data
(60) Provisional application No. 63/739,233, filed on Dec. 27, 2024.

(51) Int. Cl. G06F 9/54

(52) U.S. Cl. CPC G06F 9/547

(57) ABSTRACT

This disclosure introduces an adaptation service that addresses the brittleness of conventional Application Programming Interfaces (APIs). The system uses a generative model to dynamically translate an application's high-level service request, which can be expressed in any format, including natural language, into a specific, syntactically correct API call understood by a target service. A method for generating API calls includes receiving a service description from an application executing on a computing device and providing the service description to a generative model. The generative model generates an API call in response to receiving the service description, the API call being configured to call a service identified by the generative model based on the service description. The API call is used to obtain an output from the service, which is then used by the application, thereby enabling the application to interact with the service in a dynamic and automated manner.

### CROSS-REFERENCE TO RELATED APPLICATION

This application is a non-provisional of, and claims priority to, U.S. Provisional Application No. 63/739,233, filed on Dec. 27, 2024, entitled “Open-Vocabulary Application Programming Interface Calls”, the disclosure of which is incorporated herein by reference in its entirety.

### BACKGROUND

Application programming interfaces (APIs) make functionality provided by a service (e.g., library/module) available to other applications. An API identifies input parameters expected by the service and output parameters provided to the calling application. APIs need to be available to application developers before they develop their application. APIs can evolve over time because when the developer of the service adds additional functionality or changes the functionality, that developer adapts the API.

### SUMMARY

This disclosure relates to a system that uses artificial intelligence to dynamically translate an application's request for a service into a specific command, or application programming interface (API) call, that the service can understand. Conventionally, applications are built using rigid API calls that can become outdated when a service is updated, causing the application to fail. The disclosed techniques introduce an intelligent adaptation layer that allows an application developer to describe a desired function in a flexible, high-level format, such as natural language. The AI-powered system then maps (correlates) this description to the correct, current API for the underlying platform or service. For example, an augmented reality game could ask the system to “find all chairs in the room” without needing to know the specific, predefined object categories supported by the device's object recognition service. Similarly, a smart home application could issue a general command like “dim the living room lights,” and the system would translate this into the specific API calls required by the different brands of smart bulbs installed in the user's home. This approach makes applications more resilient to changes and easier to develop across different platforms.

In some aspects, the techniques described herein relate to a method including: receiving a service description from an application executing on a computing device; providing the service description to a generative model as input; and obtaining an application programming interface call from the generative model in response to providing the service description as input, the application programming interface call being configured to call a service identified by the generative model given the service description, wherein the application programming interface call is used to obtain an output from the service, the output being processed by the application.

In some aspects, the techniques described herein relate to a method. The method includes receiving a first application program interface call from an application and providing the first application program interface call to a generative model as input. The method further includes obtaining a second application programming interface call from the generative model in response to the first application program interface call, the second application programming interface call being configured to call a service identified by the generative model based on the first application program interface call. The method also includes using the second application programming interface call to obtain an output from the service and providing the output to the application.

In some aspects, a non-transitory computer-readable medium stores instructions that, when executed, cause one or more processors to perform any of the operations or methods disclosed here. In some aspects, a system includes at least one processor and memory storing instructions that, when executed by the at least one processor, cause the computing system to perform any of the operations or methods disclosed herein.

### BRIEF DESCRIPTION OF THE DRAWINGS

The details of one or more implementations are set forth in the accompanying drawings and the description below. Other features will be apparent from the description and drawings, and from the claims.

FIG. 1 illustrates an example system supporting open-vocabulary application interface calls, according to disclosed implementations.

FIG. 2 illustrates a functional diagram of an application programming interface adaptation service, according to disclosed implementations.

FIG. 3 illustrates an example flow diagram of a method of obtaining an application programming interface call using a service description, according to disclosed implementations.

FIG. 4 illustrates an example flow diagram of a method of obtaining an application programming interface call using a requested application interface call, according to disclosed implementations.

FIG. 5 illustrates an instance of a computing system that can be used to provide open vocabulary (dynamic) API calls, according to an implementation.

### DETAILED DESCRIPTION

At least one technical problem with conventional software architectures is the brittleness of tightly coupled application programming interfaces (APIs). Calling applications are compiled with static links to specific API endpoints, function signatures, and data structures. Consequently, if a service's API is updated—for example, by changing a parameter name, data format, or endpoint address—the pre-compiled application will fail at runtime due to invocation errors or data parsing failures. This tight coupling creates a fragile system that requires constant manual code updates and redeployment of applications to maintain functionality. Another technical problem is the proliferation of platform-specific APIs, which forces developers to implement and maintain distinct, non-interoperable codebases for different operating systems, increasing system complexity and computational overhead.

At least one technical solution is a computing system implementing an API adaptation service that functions as a dynamic, intelligent intermediary between an application and a service. This service utilizes a specifically configured generative model to dynamically generate a valid, machine-executable API call in response to a high-level, format-agnostic service description from the application. This dynamic mapping service reduces the need for manual adaptations by calling programs and overcomes the static binding limitations of conventional systems by performing a real-time transformation of the application's semantic intent to the syntax required by the target service's current API. More specifically, the API adaptation service enables developers to describe a needed API in text form and enables service providers (API developers) to provide a description of what the API supports. Such mappings may be performed in real-time (seconds or less) on the client device to mitigate delay in providing a response. The description of the API may also include additional documents/background information. The API adaptation service uses a large language model to dynamically map the calling application's description to API functionality. The descriptions can be in human-readable format such as text or images or computer-readable form, e.g., embeddings, JSON objects, XML objects, etc. This dynamic approach avoids the rigidity of direct API calls, enabling calling applications that are not maintained to continue functioning where they would otherwise be unable to use the modified API, while operating in a real-time environment.

At least one technical benefit of disclosed implementations is the ability to enable a calling program to use an API that was not yet available when the calling program was last published. As an example, many extended reality (XR) devices use semantic segmentation, which enables applications running on the device to recognize and distinguish various objects, for example, to know whether the object in front of the user is a wall, a table, a chair, a person, etc. Today's semantic segmentation applications use application program interfaces with a fixed set of classes, or in other words a closed set of classes. This means that applications calling a semantic segmentation application program interface are limited to asking for/getting back one or more classes from the fixed set. But additional classes can be added and/or a developer can at some point provide an open-set request via its API. Open-set semantic segmentation services aim to provide the ability to search for arbitrary elements in the scene by supplying a short textual description instead of a fixed set of classes. In other words, an open-set semantic segmentation service are not limited to identifying a set of fixed, pre-determined classes. Closed-set classifiers perform well on the identified sets (high quality). The open-set classifiers used by semantic segmentation services perform well and offer great flexibility, but they may not perform as well as closed-set classifiers for the specific class the closed-set classifier is for. Disclosed implementations enable a developer of a calling application to specify the precise classes desired, and the API adaptation service described by disclosed implementations can match the desired class with one of the available semantic classifiers, whether it is an API for a newly-available closed-set classifier or an API for an open-set classifier. In some implementations, the calling program can specify a preference for quality (e.g., a preference for a closed-set classifier), which the adaptation service can take into account in order to match the request with an available classifier. Thus, disclosed implementations enhance flexibility and reduce the need for constant adaptations and errors caused by outdated API calls. Put another way, disclosed implementations enable application developers to provide a custom set of classes/objects to the XR platform that matters for their particular application, instead of having to rely on a pre-defined set of semantic classes.

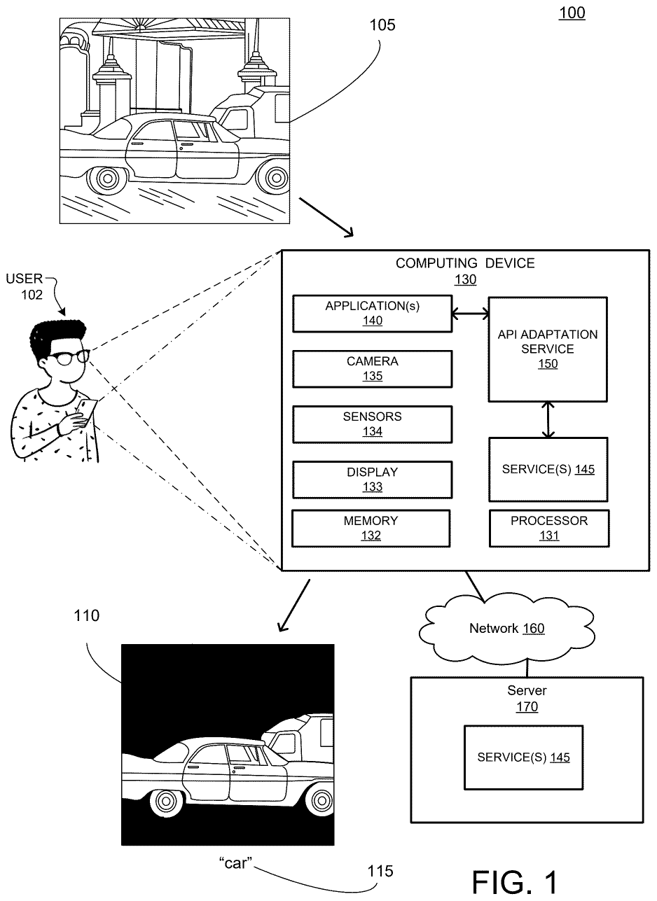

FIG. 1 illustrates an example system 100 supporting open-vocabulary application vocabulary interface calls, according to an implementation. For ease of explanation, the system 100 is described in the context of a computing device or devices supporting mixed reality (XR) applications, but implementations can be adapted to other types of applications and are not limited to an extended reality environment. For example, in a smart home environment, an application could issue a high-level command such as “secure the house for the night.” The API adaptation service would translate this into a series of specific API calls to lock smart doors, close garage doors, arm a security system, and turn off lights, even if these devices are from different manufacturers with incompatible APIs. Similarly, in a cloud computing context, a developer could describe a need for a resource, such as “deploy a scalable web server for a new application,” and the system would generate the correct sequence of API calls for a specific cloud provider's infrastructure-as-a-service platform. In the domain of enterprise software, a business analytics tool could allow a user to request “generate a report of all customer support tickets related to billing issues from the last quarter.” The adaptation service would then formulate the precise API query required by the company's customer relationship management (CRM) system, shielding the tool from the complexity of the underlying data access protocols.

In particular, the example system 100 of FIG. 1 includes one or more applications 140 that utilize one or more services 145, such as segmentation services, although implementations operate on any service or combination of services. In this example the segmentation services are configured to take an input image 105 and compute a segmentation mask 110 and label assignment 115 for the segmentation mask 110 for the input image 105. The label assignment 115 associates a region or regions, defined by the segmentation mask 110, of the image 105 with a word or words. In the example of FIG. 1 the label “car” is associated with the non-black portion of the image 105 defined by the segmentation mask 110. Each segmentation service of the service(s) 145 includes application program interface, or API, for invoking (calling) the service. The API defines the parameters needed for the service to perform its function(s) and the type of data returned. In this case, an example API for a segmentation service may identify parameters representing an image location (or the actual image data itself), a textual description of the objects to be identified for open-set segmentation (e.g., “a side table with a flower vase on it”), a predefined list of target classes for closed-set segmentation, a parameter to specify the type of segmentation (such as semantic, instance, or panoptic), a confidence threshold for filtering results, and the desired format for the output mask (e.g., a bitmap, a set of bounding boxes, or polygon coordinates).

System 100 includes computing device 130 used by a user 102. The computing device 130 is illustrated as either a smart phone or a wearable, such as smart glasses, or both, but the computing device 130 of disclosed implementations is not so limited. The computing device 130 can be a tablet, a virtual reality or extended reality headset, a server, a smart TV, a game console, a smart watch or other smart wearable device, a desktop, a laptop, or any other computing device or combination of computing devices. The computing device 130 can include, among other components, a display 133, sensors 134, camera 135, application(s) 140, service(s) 145, and API adaptation service 150. The application(s) 140, the service(s) 145, and the API adaptation service 150 may be stored as instructions in a memory, such as memory 132. In some implementations, the API adaptation service 150 may be a component of an application 140. Although illustrated as on the computing device 130, in some implementations one or more of the service(s) 145 may be services accessible by, but remote from the computing device 130. In other words, one or more of the service(s) 145 may be a service offered by a server 170 in communication with the computing device 130 via a network 160. Similarly, although illustrated as on the computing device 130, in some implementations the API adaptation service 150 may be offered by a server, such as server 170, in communication with the computing device 130 via the network 160 using one or more communication protocols.

The computing device 130 may include several hardware components including a communication module (not shown), memory 132, a processor 131, such as a central processing unit (CPU) and/or a graphics processing unit (GPU), one or more input devices, (e.g., sensors 134, camera 135, touch screen, mouse, stylus, microphone, keyboard, touchpad, buttons, etc.), and one or more output devices (e.g., display 133, speaker, vibrator, light emitter, etc.). The hardware components can be used to facilitate operation of the application(s) 140, service(s) 145, and API adaptation service 150. The hardware components can be used to facilitate operation of applications, including application(s)140, service(s) 145, API adaptation service 150, an operating system (O/S) and/or so forth of the computing device 130. The memory 132 can be used for storing information associated with applications, such as imaging application(s) 140, segmentation service(s) 145, and/or API adaptation service 150. The processor 131 can be used for processing information and/or images associated with the applications.

FIG. 1 also illustrates a server 170, which can be used in some implementations. The server 170 can include one or more processors (i.e., a processor formed in a substrate) and one or more memory devices. The server 170 may support one or more services 145 that can be called by an application 140 of a computing device 130. As such, one or more of the services 145 supported by the server can be matched with an API call from an application 140 by the API adaptation service 150.

In the specific example of FIG. 1, the application(s) 140 may include an imaging application that uses semantic understanding of a scene. Thus, the imaging application may use the camera 135 to obtain the input image 105 and/or a model (not shown) to generate the input image 105. Thus, some or part of the input image 105 can be generated. For example, in an XR environment, computer-generated graphics may be combined with a real-world image from the camera 135. The input image 105 can be any combination of a real-world image captured using the camera 135 and computer-generated content. In some implementations, camera 135 may be used to provide environment mapping, provide spatial tracking, and enable augmented reality experiences for user 102. Sensors 134 may include accelerometers and gyroscopes for tracking movement, microphones for capturing voice commands or other audio, depth sensors for spatial awareness and environment mapping, or some other type of sensor.

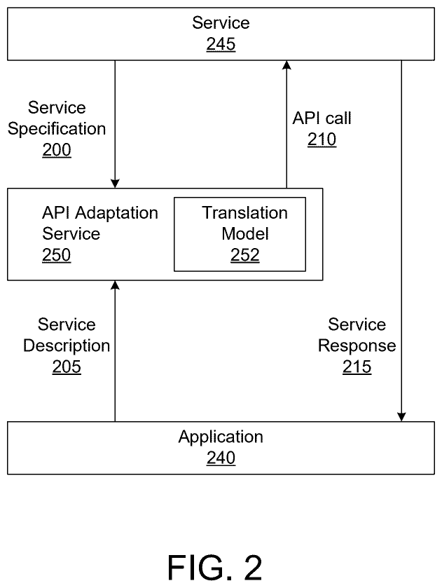

FIG. 2 illustrates a functional diagram of an API adaptation service, according to disclosed implementations. In particular, FIG. 2 illustrates an application 240 that can be one of the application(s) 140 executed by the computing device 130 of FIG. 1. The application 240 can be any application capable of execution on any computing device, including web applications, progressive web applications, mobile applications, desktop applications, etc. The application 240 uses at least one service 245. The service 245 may be one of the services(s) 145 accessible by the computing device 130 of FIG. 1. The service 245 can be any computer-executable code, i.e., a function, that provides an API for calling the function. Put another way, the service 245 may be remote from the computing device executing the application 240 or the service 245 may execute on the same computing device as the application 240. In other words, although not shown in FIG. 2, a network, such as network 160, can be used to make the API call 210 and/or to provide the service response 215.

FIG. 2 further includes an API adaptation service 250. The API adaptation service 250 is an example of the API adaptation service 150 of FIG. 1. In some implementations, the API adaptation service 250 can be an application offered as a service, e.g., that executes on a server and accessible to the service 245 and the application 240, e.g., via network 160. In some implementations, the API adaptation service 250 may be bundled with the application 240. In other words, even if no services have provided a service specification 200, the developer of the application 240 may implement an API adaptation service 250 configured to perform the mapping of a service description to one or more services, where the developer of the application 240 has provided a description, e.g., a service specification 200, of those particular services. Such an implementation can support a transition phase where many services and/or platforms are not supporting an API adaptation service 250 natively.

In some implementations, the developer of the service 245 may implement API adaptation service 250. In such an implementation, the API adaptation service 250 can be configured to translate traditional calls from applications (e.g., application 240) to a valid API call to the service 245. This implementation would prevent an outdated API call from an application from failing during a transition phase where applications are not taking advantage of the dynamic calls provided by the API adaptation service 250. The API adaptation service 250 may be configured to validate input received from the application 240 to ensure it does not contain malicious, manipulated, or malformed data that could compromise the service 245. Beyond security validation, the API adaptation service 250 can leverage a knowledge base of known issues or bugs within the service 245 and automatically apply known workarounds during the translation process. For example, if a specific service parameter causes a crash under certain conditions, the adaptation service 250 can detect this condition in the application's request and modify the generated API call to avoid the crash while still fulfilling the intent of the request.

The API adaptation service 250 can be or can include a translation model 252. The translation model 252 is a generative model based on a transformer architecture, which is technically well-suited for this task due to its attention mechanisms. These mechanisms allow the model to effectively weigh the significance of different parts of the input service description and map the semantic relationships between the application's intent and the specific parameters, syntax, and structure of a target API. The translation model 252 may be a specially trained model, or in other words a fine-tuned model, configured to predict a service (e.g., service 245) and generate a syntactically correct API call for it given a description of the desired API, i.e., service description 205. The service description 205 can also be referred to as an API description. As used herein, a “service description” is a high-level, format-agnostic abstraction of a service request that semantically conveys the intent of an application, enabling a generative model to map the intent to a concrete application programming interface call for a target service. A service description can include any text that describes or lists the input data element(s) provided by the application 240 and a function name or other text describing the action to be taken on the input data. The service description 205 can also include text describing the expected format of data returned by the API. The service description 205 need not have any particular format and can be written in natural language, as a conventional API call, or as structured data, such as an XML or JSON object. The service description 205 can be in any readable format. The service description 205 (the service description) can be provided in a mixture of natural language, text, images, or computer-readable formats (such as embeddings).

The translation model 252 may be trained using few-shot training examples of service descriptions to valid API calls. For example, the translation model 252 may be provided with examples of service descriptions that use the various formats (natural language, API calls, structured data) and an indication of a valid API call for each example. For instance, for the car segmentation example shown in FIG. 1, a training example for the translation model 252 could include a natural language service description such as “Find the car in the provided image and return its segmentation mask.” Another training example could use a deprecated API call format, such as segment(image=image_data, object=‘car’). A third example could use a structured JSON object, like {‘task’: ‘segmentation’, ‘target’: ‘car’, ‘source’: ‘image_data’}. For each of these service descriptions, the training data would indicate that the corresponding valid API call is segmentation_service. execute(image=image_data, query=‘car’, output=‘mask’.

In some implementations, the API adaptation service 250 can be configured to identify attached data included in the service description 205. The attached data can be directly included in the service description or can be indirectly included through inclusion of a resource identifier, such as a file path, resource locator (e.g., URL), parameter address, or other such identifier that uniquely identifies the attached data. Attached data represents parameters (data elements) needed for the API call but not needed by the translation model 252 to translate the service description 205 to an API call 210. For example, an image file (image data) may be needed for the API call but the actual image data is not needed to translate the service description 205 to the API call 210. In this example, the file itself, or in other words the image data, is considered attached data. Similarly, other attached data, such as documents, audio or video files, 3D model data, large datasets, or data objects, may not be needed by the translation model 252 to generate the API call 210 from the service description 205. The API adaptation service 250 may identify and exclude attached data from the input to the translation model 252. For example, the API adaptation service 250 may be configured to look for resource identifiers in the service description and exclude such identifiers from the input provided to the translation model 252. As another example, the API adaptation service 250 can be configured to identify structured data elements used to hold attached data (input parameter data) to exclude from the input provided to the API adaptation service 250. In some implementations, the API adaptation service 250 does not exclude any part of the service description.

The API adaptation service 250 may receive a service specification from the service 245. The service specification, e.g., such as service specification 200, can also be referred to as a service expectation or service API expectation. A service specification describes what the service 245 does, what it expects (input parameters), and what it provides (output parameters). The API adaptation service 250 may receive the service specification 200 as part of training the translation model 252. The API adaptation service 250 may receive the service specification 200 periodically, such as when a new service seeks to be natively supported by the API adaptation service 250, and/or when a service 245 has an update to its API. A service specification 200 received periodically is referred to as an updated service specification. Such an updated service specification can be used to update the generative model.

When a service specification 200 is received by the API adaptation service 250, it may be used to update the translation model 252. For example, the new service specification 200 may be provided to the translation model 252 for processing.

The service specification 200 can be provided by the developer of the service 245. The service specification 200 can be provided in any readable format. The service specification 200 can be provided in a mixture of natural language, text, images, computer code, pseudocode, text-based documentation, a sample app, usage examples, and/or computer-readable formats (such as embeddings). The service specification 200 may describe what the service 245 does. The service specification 200 may describe what the service 245 expects as parameters, i.e., what the service expects. The service specification 200 may describe what the service 245 provides as output, i.e., what the service 245 provides. The service specification 200 may include additional description that may be of use in mapping requests to the service 245. The additional description may take the form of additional documents and/or background information. For example, the additional description could provide a clarification of the service. In an example where the service is a segmentation model operating on furniture, the additional description may include a statement that in order to differentiate between desks and tables, the model considers desks to have a computer or to have two or more drawers, otherwise the service will identify the object as a table. In some implementations, the additional description can be provided as an identifier of a file (e.g., PDF, webpage, plain text file, manifest, an image file, etc.). In such an implementation, the API adaptation service 250 may obtain the contents of the file and provide the contents to the translation model 252 for processing.

A service 245 that provides a service specification 200 to the API adaptation service 250 supports (participates in) native dynamic mapping. In some implementations, a service specification 200 may be received from an application developer, e.g., a developer of the application 240. In such a scenario, the service 245 is considered not to support native dynamic mapping.

The service specification 200 may be processed by the translation model 252 so that the translation model 252 can map API requests (e.g., service descriptions 205) to the service 245. This processing can occur in one of several ways. In some implementations, the service specifications are compiled into a training dataset used to fine-tune the generative translation model 252. This dataset may include pairs of example service descriptions and their corresponding, correctly formatted API calls derived from the specification. In other implementations, to enable real-time adaptability without the computational expense of retraining, the system employs a technique known as Retrieval-Augmented Generation (RAG). With this technique, the API adaptation service 250 maintains a library of available service specifications. When a service description is received, the adaptation service retrieves the most relevant specifications from the library (e.g., using a vector similarity search) and provides them to the translation model 252 as context. This RAG-based architecture allows the model to generate correct API calls for services it was not explicitly fine-tuned on. Without the latency and resource consumption of a full model retraining cycle. Put another way, once the translation model 252 has processed a service specification 200 (either through fine-tuning or RAG-based techniques), the API adaptation service 250 is able to translate (map) a service description 205 received from an application 240 into a call to the service 245. Translation can include not only selection of the service 245 but also arranging information in a service description 205 in a format expected by the service 245, i.e., into a valid API call for the service.

At some future time (e.g., subsequent to processing the service specification 200), the API adaptation service 250 receives a service description 205. The service description 205 includes a description of an expected (needed, desired) service and/or API. The service description 205 includes a description of what the application 240 wants, i.e., an expected response. The service description 205 may include a description of data to include in the response. The service description 205 may be augmented with one or more images (image data) to help the service disambiguate the request. For example, a request to “find objects that look like this” would include an image. In such cases, the translation model 252 may be a multi-modal generative model capable of processing both text and image inputs to generate the correct API call. The service description 205 may include a device type (e.g., mobile, tablet, desktop), reflecting the requesting device. The service description 205 may include an identification of the platform (operating system) of the requesting device. The service description 205 can include any other data that can be used as input/provided as input to the service. The service description 205 may include attached data. The attached data may be part of the service description 205 or may be identified in the service description 205. For example, the service description 205 may include a location of a file (image, document, etc.), data representing an image, data representing a document. The service description 205 can include a prompt. The service description 205 or a portion of the service description 205 may be in a natural language format. The service description 205 or a portion of the service description 205 may be in a text format. The service description 205 or a portion of the service description 205 may be in any readable format, including a computer-readable format. The service description 205 can be provided in a mixture of natural language, text, or computer-readable formats.

In response to receiving the service description 205, the API adaptation service 250 may provide the service description 205 to the translation model 252 for processing. As indicated above, the translation model 252 generates API call 210 given the service description 205 as input. In some implementations, the API adaptation service 250 sends the API call 210 to the application 240 and the application 240 makes the API call to the service 245 and the service 245 sends a service response 215 to the application 240. In some implementations, the API adaptation service 250 makes the API call on behalf of the application 240. In such an implementation, the service 245 receives the API call 210 and provides a service response 215 to the API adaptation service 250, which passes the service response 215 to the application 240.

The architecture shown in FIG. 2 provides significant advantages by decoupling the application 240 from the underlying service 245 through the API adaptation service 250. This arrangement creates a resilient and forward-compatible system where applications can request functionality using a high-level description without being tied to a specific, rigid API that might change over time or differ across platforms. For instance, a travel application could request a service to ‘find a quiet, romantic hotel near the Eiffel Tower with a good view,’ and the adaptation service could translate this into the correct API call for various hotel booking platforms, each with its own proprietary API structure. Similarly, a cloud storage application could describe a need to ‘upload a file with high redundancy,’ allowing the adaptation service to select and call the most appropriate storage service API—be it for archival or high-availability storage—based on the service specifications it has processed, without requiring the application developer to code for each specific service.

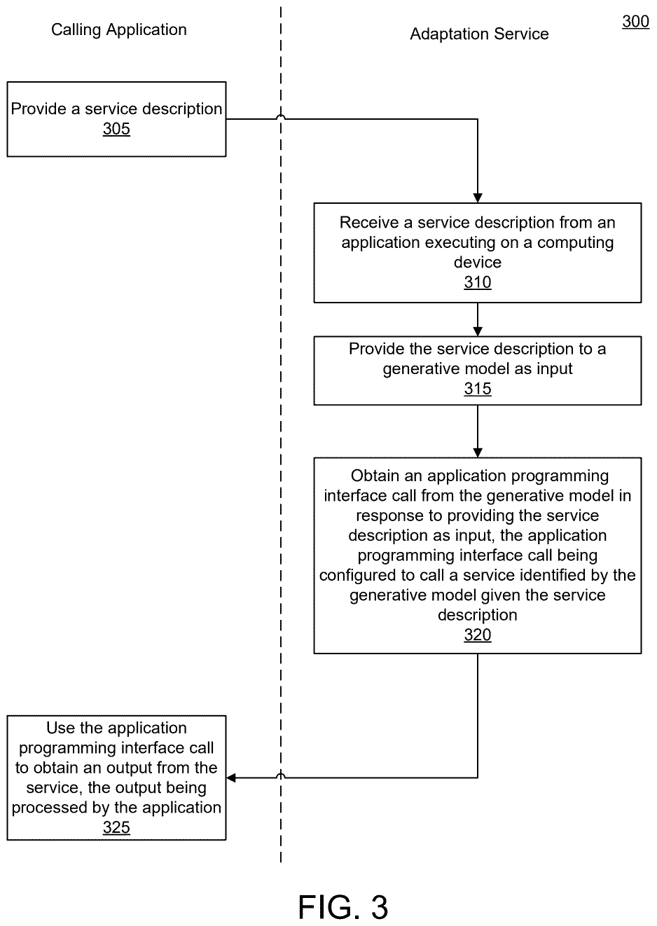

FIG. 3 is a flowchart of an example method 300 of obtaining an application programming interface call using a service description, according to disclosed implementations. In FIG. 3, some steps are illustrated as being performed by a calling application, such as application 240 of FIG. 2, while other steps are illustrated as being performed by an adaptation service, such as adaptation service 250 of FIG. 2. However, implementations are not so limited and in some implementations one or more of the steps illustrated as being performed by the calling application may be performed by the adaptation service. Moreover, in some implementations, the calling application may implement the adaptation service.

Method 300 begins at step 305, where the calling application provides a service description to the adaptation service. The calling application is an application executing on a computing device, such as computing device 130 of FIG. 1. The service description can be a representation of the functionality the application needs and its inputs and outputs. The service description can be provided in a variety of formats, including natural language text, structured data such as a JSON object, or even a conventional API call. For example, a service description requesting a segmentation function could include a textual prompt like “find all vehicles in the image, where vehicles include bicycles, motorcycles, delivery trucks, buses, trucks, or cars but exclude scooters”. The service description can also include image data or a location of image data. The service description could also be a JSON object specifying an open-set segmentation task with the class “vehicle” and a reference to the image data.

The adaptation service receives the service description from the calling application at step 310 and may parse the description to prepare the service description for use as input to a generative model, such as the translation model 252 of FIG. 2. Parsing the description can include identifying and separating attached data, such as image files or large data objects, from the textual or structured parts of the description that define the desired functionality. For example, if the service description includes a natural language prompt and a reference to an image file, the parsing step may extract the prompt for the generative model while setting aside the image file reference to be included as a parameter in the final generated API call. In another example, if the service description includes a prompt like “find objects that look like the one in this image” and an image reference (e.g., location identifier) is included in the prompt, the parsing step may involve retrieving the image data and providing it, along with the prompt, to the generative model. In this scenario, the visual content of the image helps the generative model to disambiguate the request and select the most appropriate API, such as an open-set segmentation service that accepts image-based queries. In some implementations, no parsing of the service description is performed and the service description is used as received from the calling application.

At step 315, the service description, potentially parsed and edited as part of step 310, is provided to a generative model as input. At step 320, the adaptation service receives an application programming interface call from the generative model. The application programming interface call is received in response to providing the service description as input to the model, i.e., as or as part of a prompt to the model. The prompt may include an instruction to generate an API call that corresponds to the service description. In cases where the generative model cannot identify a matching service or generate a valid API call for the given service description, the adaptation service may be configured to return a specific error message, a null response, or a list of the closest available services to the calling application. The specific error message may include diagnostic information to assist the user or application in understanding the cause of the failure. For instance, the error message may differentiate between scenarios where the request is understood by the system but the service simply does not provide the requested functionality, versus scenarios where the translation layer is unable to parse the request or the service specification. This distinction can inform the user or system whether a newer or more capable translation layer, or perhaps additional context (e.g., retrieved from the internet), might be needed to resolve the issue. The application programming interface call returned by the model can be used to obtain an output from the service, e.g., by making an API request to the service identified in the API call. In some implementations, such as the one illustrated in FIG. 3, the adaptation service provides the API call to the calling program. In some implementations, the adaptation service may make the API request itself and send the output (the response for the API call) to the calling program.

At step 325, the application programming interface call is used to obtain an output from the service. While illustrated in FIG. 3 as the calling application using the application programming interface call to obtain the output, in some implementations, the adaptation service may obtain the output and pass the output to the calling application. The calling application then processes (uses) the output. Method 300 illustrates that by acting as an intelligent intermediary, the adaptation service allows the application to request functionality using a flexible, high-level description. This approach provides benefits, such as enhanced application resilience against API updates and platform variations, reduced maintenance overhead for developers, and the ability to leverage new or updated services without requiring modifications to the calling application's code.

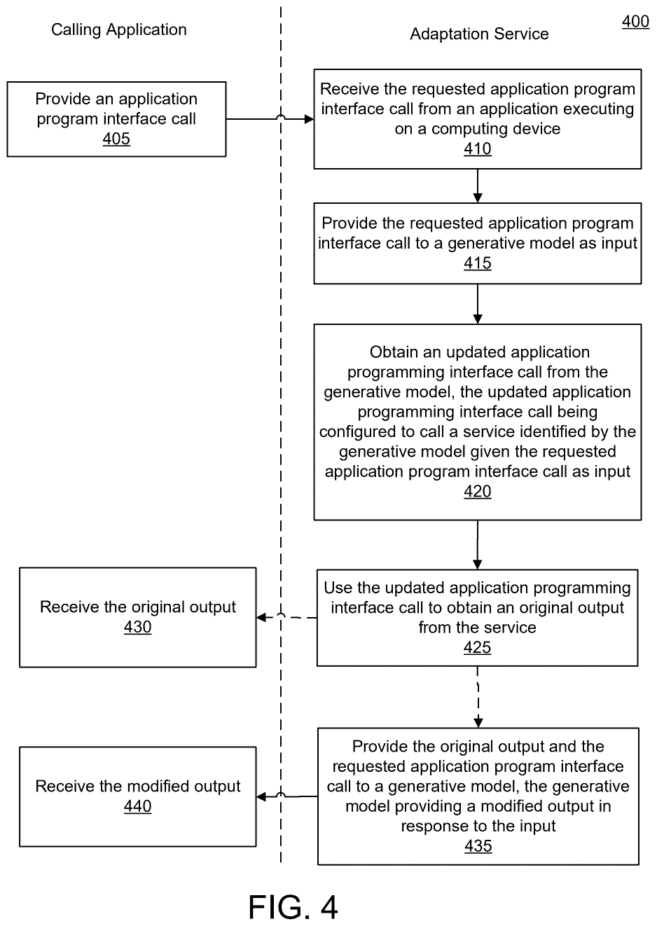

FIG. 4 is a flowchart of an example method 400 of obtaining an updated application programming interface call using a requested application programming interface call, according to disclosed implementations. In FIG. 4, some steps are illustrated as being performed by a calling application, such as application 240 of FIG. 2, while other steps are illustrated as being performed by an adaptation service, such as adaptation service 250 of FIG. 2. However, implementations are not so limited, and in some implementations one or more of the steps illustrated as being performed by the adaptation service may be performed by the calling application. Moreover, in some implementations, a service identified in the API call may implement the adaptation service.

Method 400 begins at step 405 with the calling application providing an API call associated with a service, also referred to as a first API call. The API call is used to obtain desired functionality from the service. The API call may be a conventional API call. The API call can be a deprecated API call. A deprecated API call is a standard API call that has been retired, i.e., no longer supported by the service. At step 410, the adaptation service receives the first API call. The adaptation service may be running on the computing device that the calling application is running on. The adaptation service may be implemented by the service associated with the API call. Such a service may be running locally on the computing device with the calling application or the service may be running on a remote computing device communicatively coupled to the local computing device.

At step 410, in some implementations, the adaptation service may determine whether the API call (the first API call) can be acted upon as it was received. In such implementations, the adaptation service may determine that no updated API call is needed, skip to a modified step 425, where the received API call is used to obtain an original output. Alternatively, if the API call cannot be acted upon as received, e.g., because it is a deprecated API call or does not otherwise correspond to a known API definition, the adaptation service can continue with method 400 by providing the API call to a generative model as input, e.g., at step 415. In some implementations, the received API call is provided to the generative model without making any determination on whether the API call can be acted upon as it was received. At step 415, when the API call is provided to the generative model, it may be provided with, e.g., as part of, a prompt that instructs the model to provide an updated API call that can be used to perform the function identified in the received (original) API call.

At step 420, the adaptation service receives an updated application programming interface call from the generative model. This updated application programming interface call can also be referred to as a second application programming interface call. The updated application programming interface call is received in response to providing the received application program interface call as input to the model, i.e., as or as part of a prompt to the model. In cases where the generative model cannot identify a matching service or generate a valid API call, e.g., because a confidence is too low/below a threshold, the adaptation service may return a specific error message to the calling application. Alternatively, the adaptation service could return a list of the most likely or similar available services, allowing the application to select a fallback or inform the user of the available options. At step 425, the updated application programming interface call returned by the model can be used to obtain an output from the service, e.g., by making an API request to the service identified in the updated API call.

In some implementations, the adaptation service provides the original output to the calling application, where the output is received (at step 430) as a response to the API call made in step 405. In some implementations, the original output obtained in response to the updated API call may not be in a format expected by the calling application. In such implementations, at step 435, the adaptation service may convert the original output to a modified output, or in other words into an output expected by the calling application. In some implementations, the adaptation service may obtain the modified output from a generative model. The generative model can be the same generative model that provided the updated API or it can be a different model. The adaptation service may provide the generative model with a prompt that asks the model to convert the original output to the output expected by the received API call. Put another way, the model may be asked to generate a modified output that has a format specified by the API definition corresponding to the received API call. The adaptation service may send the modified output to the calling application, which receives the modified output at step 440 as the response to the application program interface call made in step 405.

Method 400 provides a mechanism for ensuring backward compatibility for applications that use deprecated or outdated API calls or that use forward-looking (not yet supported) API calls. By intercepting a potentially outdated API call, the adaptation service leverages a generative model to translate it into a valid, current API call for the intended service. This process not only identifies the correct updated function but can also reformat the data returned by the service to match the structure expected by the original, outdated API call. This ensures that legacy applications continue to function without requiring immediate code modifications, thereby reducing maintenance overhead for developers and allowing service providers to evolve their APIs without disrupting existing users. The method effectively creates a dynamic translation layer that bridges the gap between old application logic and new service interfaces.

Disclosed implementations provide the benefit of reducing adaptations needed to connect applications and services. For example, application developers no longer need to adapt their application to the specific set of semantic classes that a platform provides. Instead, the application developer can specify a set of classes, possibly augmented with a longer textual description of what they are looking for and/or an additional image(s) to further disambiguate. As another example, application developers no longer need to adapt their application to newer APIs or different platforms, assuming that a similar capability exists on all platforms. As another example, application developers can make use of open-set semantic segmentation services. For example, a hide-and-seek application may require players to find certain objects in their homes. While it might be possible to re-use an existing set of classes (“sofa”, “chair”, “window”) etc., as part of the game, this results in a limited experience. Instead, using the API adaptation service, a game developer could ask the user to spot any object as long as they can describe it in text form (or by example). That description can then be used as a service description provided by the game to the API adaptation service, which can select the proper service (segmentation model) to predict whether the images provided by the game include that object.

In another example, a smart home application could receive a voice command to “turn off all lights in the living room.” The application would generate a generic service description for this action. The adaptation service, aware of the different APIs for various smart light brands installed in the home, would then generate the specific, correctly formatted API call for each distinct service, enabling seamless control over a heterogeneous device ecosystem. In another example, an augmented reality (AR) interior design application could allow a user to find a place for a virtual object by describing a need to “identify all clear, horizontal surfaces.” The adaptation service could interpret this request and generate a call to an open-set semantic segmentation service on the device, which returns the coordinates of suitable surfaces without the application needing to know the specific name or parameters of the platform's segmentation API. As a final example, a business intelligence tool could allow an analyst to request “quarterly sales data for a specific product in Europe.” The adaptation service would parse this request and translate it into a precise query for the appropriate corporate sales database API, abstracting the complexity of different data source APIs from the end-user.

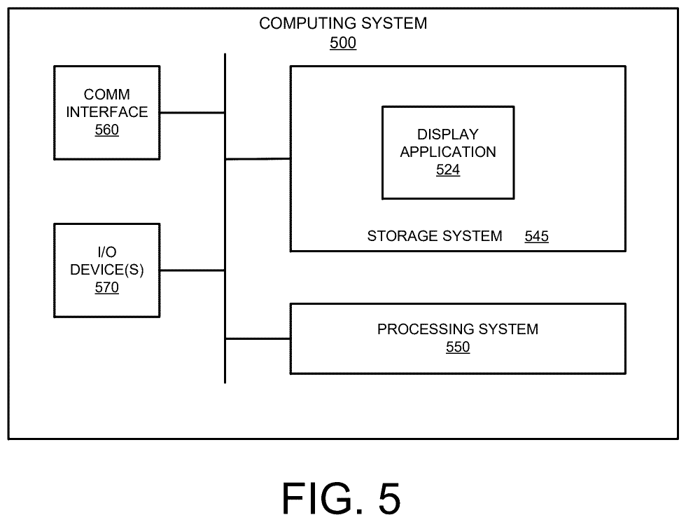

FIG. 5 illustrates an instance of a computing system 500 that can be used to provide open vocabulary (dynamic) API calls, according to an implementation. Computing system 500 is representative of any computing system or systems with which the various operational architectures, processes, scenarios, and sequences disclosed herein can be implemented to provide an interface for a user. For example, computing system 500 may be representative of a back-end component (e.g., as a data server), a middleware component (e.g., an application server), or a front-end component (e.g., a client computer having a graphical user interface and/or a Web browser through which a user can interact with an implementation of the systems and techniques described here). For example, computing system 500 may represent a wearable computing device, such as an XR device or smart glasses. Computing system 500 can include multiple computing devices in some examples (e.g., a wearable device and a companion device, such as a smartphone or tablet). Computing system 500 can be an example of server 170 of FIG. 1. Implementations can include any combination of such back-end, middleware, or front-end components. Moreover, the components of the system can be interconnected by any form or medium of digital data communication (e.g., a communication network such as network 160 of FIG. 1). Examples of communication networks include a local area network (“LAN”), a wide area network (“WAN”), and the Internet. Instances of the computing system 500 can include clients and servers. A client and server are remote from each other and typically interact through a communication network, such as network 160 of FIG. 1. The relationship of client and server arises by virtue of computer programs running on the respective computers and having a client-server relationship with each other.

Computing system 500 includes storage system 545, processing system 550, communication interface 560, and input/output (I/O) device(s) 570. Processing system 550 is operatively linked to communication interface 560, I/O device(s) 570, and storage system 545. In some implementations, communication interface 560 and/or I/O device(s) 570 may be communicatively linked to storage system 545. Computing system 500 may further include other components, such as a battery and enclosure, that are not shown for clarity.

Communication interface 560 comprises components that communicate over communication links, such as network cards, ports, radio frequency, processing circuitry and software, or some other communication devices. Communication interface 560 may be configured to communicate over metallic, wireless, or optical links. Communication interface 560 may be configured to use Time Division Multiplex (TDM), Internet Protocol (IP), Ethernet, optical networking, wireless protocols, communication signaling, or some other communication format, including combinations thereof. Communication interface 560 may be configured to communicate with external devices, such as servers, user devices, or some other computing device.

I/O device(s) 570 may include computer peripherals that facilitate the interaction between the user and computing system 500. Examples of I/O device(s) 570 may include keyboards, mice, trackpads, monitors, displays, printers, cameras, microphones, external storage devices, and the like.

Processing system 550 comprises microprocessor circuitry (e.g., at least one processor) and other circuitry that retrieves and executes operating software from storage system 545. Storage system 545 may include volatile and nonvolatile, removable, and non-removable media implemented in any method or technology for information storage, such as computer-readable instructions, data structures, program modules, or other data. Storage system 545 may be implemented as a single storage device, but may also be implemented across multiple storage devices or sub-systems. Storage system 545 may comprise additional elements, such as a controller to read operating software from the storage systems. Examples of storage media (also referred to as computer-readable storage media) include random access memory, read-only memory, magnetic disks, optical disks, and flash memory, as well as any combination or variation thereof or any other type of storage media. In some implementations, the storage media may be non-transitory. In some instances, at least a portion of the storage media may be transitory. In no case is the storage media a propagated signal.

Processing system 550 is typically mounted on a circuit board that may hold the storage system. The operating software of storage system 545 comprises computer programs, firmware, or another form of machine-readable program instructions. The operating software of storage system 545 comprises display application 524. The operating software on storage system 545 may include an operating system, utilities, drivers, network interfaces, applications, or other types of software. When read and executed by processing system 550, the operating software on storage system 545 directs computing system 500 to operate as described in the previously described FIGS. 1-4.

The computing system can include clients and servers. A client and server are remote from each other and typically interact through a communication network. The relationship of client and server arises by virtue of computer programs running on the respective computers and having a client-server relationship with each other.
Clause 1. A method comprising: receiving a service description from an application executing on a computing device; providing the service description to a generative model as input; and obtaining an application programming interface call from the generative model in response to providing the service description, the application programming interface call being configured to call a service identified by the generative model based on the service description, wherein the application programming interface call is used to obtain an output from the service, the output being used by the application.
Clause 2. The method of clause 1, wherein the service description includes attached data and the method further comprises: identifying the attached data; excluding the attached data from the service description provided to the generative model; and including the attached data in the application programming interface call.
Clause 3. The method of clause 2, wherein the attached data includes an identifier of a file and the identifier is used to identify the attached data.
Clause 4. The method of clause 1, further comprising: receiving an updated service specification from the service; and updating the generative model using the updated service specification.
Clause 5. The method of clause 4, wherein the updated service specification includes an identifier of a file and the method further comprises: using the identifier to obtain contents of the file; and including the contents of the file in the updated service specification provided to the generative model.
Clause 6. The method of clause 1, wherein the service description includes an object and the service is an open-set semantic segmentation service and the output is used by the application to identify areas of an image that relate to the object.
Clause 7. The method of clause 1, wherein using the application programming interface call to obtain the output includes: sending the application programming interface call to the service on behalf of the application; receiving a service response from the service; and providing the service response to the application.
Clause 8. The method of clause 1, further comprising: parsing the service description to prepare the service description for use as the input to the generative model.
Clause 9. The method of clause 1, wherein providing the service description to the generative model as input includes providing a prompt to the generative model, the prompt including the service description and an instruction to generate the application programming interface call.
Clause 10. A non-transitory computer-readable medium storing instructions that, when executed by at least one processor, cause the processor to perform operations comprising: receiving a first application program interface call from an application; providing the first application program interface call to a generative model as input; obtaining a second application programming interface call from the generative model in response to providing the first application program interface call as input, the second application programming interface call being configured to call a service identified by the generative model given the first application program interface call; using the second application programming interface call to obtain an output from the service associated with the second application programming interface call; and providing the output to the application.
Clause 11. The non-transitory computer-readable medium of clause 10, wherein providing the output to the application includes: providing the output and the first application program interface call to the generative model as input; obtaining a modified output from the generative model, the modified output having a format that corresponds to a format expected by the first application program interface call; and providing the modified output to the application.
Clause 12. The non-transitory computer-readable medium of clause 10, wherein the first application program interface call is a deprecated application program interface call.
Clause 13. The non-transitory computer-readable medium of clause 10, wherein providing the first application program interface call to the generative model as input comprises providing a prompt to the generative model, the prompt including the first application program interface call and an instruction to generate the second application programming interface call.
Clause 14. The non-transitory computer-readable medium of clause 10, wherein the operations further comprise determining that the first application program interface call is incompatible with the service, and wherein providing the first application program interface call to the generative model is performed in response to the determination.
Clause 15. The non-transitory computer-readable medium of clause 10, wherein the operations are performed by the service associated with the second application programming interface call.
Clause 16. A system comprising at least one processor and memory storing instructions that, when executed by the at least one processor, cause the system to perform any of the methods or operations of clauses 1 through 16.

In this specification and the appended claims, the singular forms “a,” “an” and “the” do not exclude the plural reference unless the context clearly dictates otherwise. Further, conjunctions such as “and,” “or,” and “and/or” are inclusive unless the context clearly dictates otherwise. For example, “A and/or B” includes A alone, B alone, and A with B. Further, connecting lines or connectors shown in the various figures presented are intended to represent example functional relationships and/or physical or logical couplings between the various elements. Many alternative or additional functional relationships, physical connections or logical connections may be present in a practical device. Moreover, no item or component is essential to the practice of the implementations disclosed herein unless the element is specifically described as “essential” or “critical”.

Terms such as, but not limited to, approximately, substantially, generally, etc. are used herein to indicate that a precise value or range thereof is not required and need not be specified. As used herein, the terms discussed above will have ready and instant meaning to one of ordinary skill in the art.

Moreover, use of terms such as up, down, top, bottom, side, end, front, back, etc. herein are used with reference to a currently considered or illustrated orientation. If they are considered with respect to another orientation, it should be understood that such terms must be correspondingly modified.

Although certain example methods, apparatuses and articles of manufacture have been described herein, the scope of coverage of this patent is not limited thereto. Terminology employed herein is for the purpose of describing particular aspects and is not intended to be limiting. On the contrary, this patent covers all methods, apparatus and articles of manufacture fairly falling within the scope of the claims of this patent.

What is claimed is:

1. A method comprising:
receiving a service description from an application executing on a computing device;
providing the service description to a generative model as input; and
obtaining an application programming interface call from the generative model in response to providing the service description, the application programming interface call being configured to call a service identified by the generative model based on the service description,
wherein the application programming interface call is used to obtain an output from the service, the output being used by the application.

2. The method of claim 1, wherein the service description includes attached data and the method further comprises:
identifying the attached data;
excluding the attached data from the service description provided to the generative model; and
including the attached data in the application programming interface call.

3. The method of claim 2, wherein the attached data includes an identifier of a file and the identifier is used to identify the attached data.

4. The method of claim 1, further comprising:
receiving an updated service specification from the service; and
updating the generative model using the updated service specification.

5. The method of claim 4, wherein the updated service specification includes an identifier of a file and the method further comprises:
using the identifier to obtain contents of the file; and
including the contents of the file in the updated service specification provided to the generative model.

6. The method of claim 1, wherein the service description includes an object and the service is an open-set semantic segmentation service and the output is used by the application to identify areas of an image that relate to the object.

7. The method of claim 1, wherein using the application programming interface call to obtain the output includes:
sending the application programming interface call to the service on behalf of the application;
receiving a service response from the service; and
providing the service response to the application.

8. The method of claim 1, further comprising:
parsing the service description to prepare the service description for use as the input to the generative model.

9. The method of claim 1, wherein providing the service description to the generative model as input includes providing a prompt to the generative model, the prompt including the service description and an instruction to generate the application programming interface call.

10. A computing system comprising:
at least one processor; and
memory storing instructions that, when executed by the at least one processor, cause the computing system to perform operations including:
receiving a service description from an application executing on a computing device,
providing the service description to a generative model as input, and
obtaining an application programming interface call from the generative model in response to providing the service description, the application programming interface call being configured to call a service identified by the generative model based on the service description,
wherein the application programming interface call is used to obtain an output from the service, the output being used by the application.

11. The computing system of claim 10, wherein the service description includes attached data and the operations further comprise:
identifying the attached data;
excluding the attached data from the service description provided to the generative model; and
including the attached data in the application programming interface call.

12. The computing system of claim 10, further comprising:
receiving an updated service specification from the service; and
updating the generative model using the updated service specification.

13. The computing system of claim 10, wherein using the application programming interface call to obtain the output includes:
sending the application programming interface call to the service on behalf of the application;
receiving a service response from the service; and
providing the service response to the application.

14. The computing system of claim 10, further comprising:
parsing the service description to prepare the service description for use as the input to the generative model.

15. The computing system of claim 10, wherein providing the service description to the generative model as input includes providing a prompt to the generative model, the prompt including the service description and an instruction to generate the application programming interface call.

16. A non-transitory computer-readable medium storing instructions that, when executed by at least one processor, cause the processor to perform operations comprising:
receiving a first application program interface call from an application;
providing the first application program interface call to a generative model as input;
obtaining a second application programming interface call from the generative model in response to providing the first application program interface call as input, the second application programming interface call being configured to call a service identified by the generative model given the first application program interface call;
using the second application programming interface call to obtain an output from the service associated with the second application programming interface call; and
providing the output to the application.

17. The non-transitory computer-readable medium of claim 16, wherein providing the output to the application includes:
providing the output and the first application program interface call to the generative model as input;
obtaining a modified output from the generative model, the modified output having a format that corresponds to a format expected by the first application program interface call; and
providing the modified output to the application.

18. The non-transitory computer-readable medium of claim 16, wherein the first application program interface call is a deprecated application program interface call.

19. The non-transitory computer-readable medium of claim 16, wherein providing the first application program interface call to the generative model as input comprises providing a prompt to the generative model, the prompt including the first application program interface call and an instruction to generate the second application programming interface call.

20. The non-transitory computer-readable medium of claim 16, wherein the operations further comprise determining that the first application program interface call is incompatible with the service, and wherein providing the first application program interface call to the generative model is performed in response to the determination.

21. The non-transitory computer-readable medium of claim 16, wherein the operations are performed by the service associated with the second application programming interface call.
